(19) United States
(12) Patent Application Publication
(10) Pub. No.: US 2023/0312313 A1
(43) Pub. Date: Oct. 5, 2023

(54) CABLE WINCH

(71) Applicant: Liebherr-Components Binberach GmbH, Biberach an der Rsis (DE)

(72) Inventors: Norbert HAUSLADEN, Biberach an der Riss (DE); Thomas SCHMID, Daugendorf (DE)

(73) Assignee: Liebherr-Components Binberach GmbH, Biberach an der Rsis (DE)

(21) Appl. No.: 18/309,623

(22) Filed: Apr. 28, 2023

Related U.S. Application Data
(63) Continuation of application No. PCT/EP2021/079858, filed on Oct. 27, 2021.

(30) Foreign Application Priority Data
Oct. 30, 2020 (DE) 10 2020 128 577.9
Dec. 11, 2020 (DE) 10 2020 133 217.3

(51) Int. Cl. B66D 1/54; B66D 1/48

(52) U.S. Cl. CPC B66D 1/54; B66D 1/485

(57) ABSTRACT

The invention relates to a cable winch comprising a cable drum onto which a cable can be wound, a temperature measuring device being provided to measure the temperature of the cable drum.

### CROSS-REFERENCE TO RELATED APPLICATIONS

This application is a continuation of International Patent Application Number PCT/EP2021/079858 filed Oct. 27, 2021, which claims priority to German Patent Application Numbers DE 10 2020 128 577.9 filed Oct. 30, 2020 and DE 10 2020 133 217.3 filed Dec. 11, 2020, the contents of which are incorporated herein by reference in their entireties.

### BACKGROUND

The present invention relates to a cable winch having a cable drum onto which a cable can be wound, and to a lifting device, such as a crane, having such a cable winch. In particular, the invention relates to a cable drum for high-strength fiber ropes.

Due to their high power densities, cable winches are sometimes subject to high temperature loading, which is reflected on the one hand in the drive of the cable winch, for example a hydraulic motor or an electric motor, and on the other hand in a gear mechanism that is usually connected in between. On the other hand, however, the temperature loading of the cable to be wound up also plays a role, especially if a high-strength fiber rope or plastic cable is used, as its limit temperature is significantly lower compared to steel ropes and the influence of temperature loading on the service life of the cable must be taken into account. In principle, however, in the case of steel ropes it is likewise important to avoid excessive temperature loading or at least to be aware of it, since this can lead to a loss of lubricant from the cable and excessive grease leakage, as the case may be leading to increased wear.

From the document AU 2015/101415 A4 there is known a cable winch, the cable drum of which is driven by an electric motor, whereas the motor is controlled depending on load limits, which are offset differently for different operating modes. In this respect, the engine temperature is also monitored in order to reduce or limit the power output if the engine temperature rises too high.

The document EP 32 99 331 A1 describes a cable winch with a fiber rope, wherein it is proposed to determine the temperature of the fiber rope using embedded magnets and their magnetic field, which varies subject to temperature and is measured by magnetic field sensors. Therefore, temperature changes can be inferred from magnetic field changes. In this respect, the surface temperature of the fiber rope is also measured by means of a non-contact temperature sensor in order to be able to determine a temperature gradient between the core temperature measured via the magnetic field and the surface temperature. The paper assumes that the service life of the fiber rope suffers under excessively high temperatures, since irreversible recrystallization processes occur at temperatures above 60° C., and the cable heats up due to internal friction of the rope fibers, external friction at deflection pulleys and the ambient temperature. The winch is cooled as the case may be.

However, this type of proposed temperature measurement is in practice considered inadequate. On the one hand, changes in the magnetic field of the magnetic elements embedded in the fiber rope are not only temperature-related, but also driven by other external influences, for example inductive processes in the area of the cable winch and its drive. On the other hand, the cable can be subject to very different temperature loadings or heating processes. For example, the lower winding layers are heated from the cable drum if the cable drum heats up more, either due to the heat load of the gear mechanism usually used inside the drum or due to faults occurring during operation, such as incipient bearing damage or a seized part in the gear mechanism, which can contribute to a significant temperature increase of the cable drum in a very short time. The upper windings or even the unwound part of the cable do not experience this temperature loading, so that very different cable temperatures can result, which can hardly be measured because the lower winding layers are difficult to access for temperature sensors or the said magnets only allow inaccurate measurements due to the superimposed winding layers.

### SUMMARY

It is the underlying object of the present invention to provide an improved cable winch as well as an improved lifting device with such a cable winch of the prior art, which avoid the disadvantages of the prior art and further develop the latter in an advantageous manner. In particular, there is to be created a reliable monitoring of temperature that also takes into account the cable portions that are particularly vulnerable to heating up.

Said task is solved, according to the invention, with a cable winch as claimed in claim 1. Preferred embodiments of the invention are the subject-matter of the dependent claims.

It is therefore proposed to determine the cable drum temperature and thus enable monitoring of the heat input into the cable from the cable drum. According to the invention, the cable winch comprises a temperature measuring device for to measure the temperature of the cable drum. When the cable drum heats up, direct contact with the cable coils wound on the drum casing results in a corresponding temperature loading on the cable, so that the cable drum temperature measured or determined can be used to give a statement about the temperature loading on the cable.

This approach is based on the consideration that the cable temperature does not rise so much due to internal friction of the cable fibers or cable wires or friction at the deflection pulleys, but that the major part of the temperature loading and the associated temperature rise originates from the heat transfer from the cable drum. In this respect—surprisingly compared to a direct measurement of the cable temperature as such—a more precise statement about the temperature load and heat load of the cable can be made if the cable drum temperature is precisely determined and known.

This is because the cable drum is usually a permanent heat source during operation, which heats up the cable wound on it. Usually, an electric or hydraulic drive and a gear mechanism are used to generate a torque at the cable drum, which generates the corresponding cable traction force depending on the lever arm of the ascending or descending cable.

Due to the high power density and the resulting compact installation dimensions, cable winches with inserted planetary gears have become established in many applications. Friction at the tooth flanks and bearings, lubricant circulation and other dissipative effects generate power loss in every gear mechanism, which has a significant effect on the heat balance of the gear unit. In normal applications, this heat balance can in itself be roughly calculated in advance, but is nevertheless dependent on various parameters such as the respective load spectrum, the speeds, the ambient temperature and other influencing variables and is therefore not known in detail. In addition, unexpected and incalculable faults can occur in any gear mechanism, such as oil loss and the associated bearing heating, or seizure at the tooth flanks, which can lead to a considerable temperature increase in a very short time and, in extreme cases, can even destroy a fiber rope wound on the cable drum in the lower layers, so that a load break would have to be expected at this point when unwinding the rope. If the temperature of the cable drum is accurately determined so that the temperature at the point of contact with the cable is known, such serious hazards can be avoided.

Due to the thermal conductivity of the various components, however, even normal gearbox heating leads to significant heating of the adjacent cable drum and ultimately also to heating of the cable stored on it.

Particularly in case of high-strength fiber ropes, which can be made from synthetic fibers such as aramid fibers (HMPA), aramid/carbon fiber blends, high-modulus polyethylene fibers (HMPE) or PBO fibers, and also other synthetic ropes, the rope service life is highly temperature-dependent. With increasing cable temperature, the cable service life generally decreases, while within a certain temperature range, the service life remains almost constant. Furthermore, fiber cables have much lower limit boundary temperatures than steel ropes, up to which the rope manufacturers define the intended use of the fiber rope.

Monitoring of temperature of the cable drum can also be useful for steel wire ropes, for example to detect cable temperatures that lead to increased lubrication or grease leakage, which in turn results in premature wear.

In an advantageous further development of the invention, the temperature is determined directly at the cable drum in order to determine the drum temperature as accurately as possible. In comparison, measurements of the engine temperature or the gear oil temperature are less meaningful, since such measurements of the engine temperature or the gear oil temperature do not allow sufficiently accurate conclusions to be drawn about the current temperature of the cable drum at the point of contact with the cable, since other relevant factors such as the current oil level would not be taken into account here.

Preferably, the temperature can be determined on the gear unit side of the cable drum. On the said gear unit side, the greatest energy input into the cable drum usually occurs, so that the highest heating is to be expected there. If the temperature is determined on the said gear unit side of the cable drum, in particular a drum portion surrounding the gear mechanism or a drum portion adjacent to the gear mechanism, which may also include the lateral guard plate located on the gear mechanism side as the case may be, the highest temperature loadings of the wound-up cable can be reliably detected.

The temperature measuring device may include various temperature sensors.

In an advantageous further development of the invention, at least one stationary temperature sensor can be provided with respect to which the cable drum can rotate. Such a stationary sensor can provide its sensor signal in a simple manner or be connected in a simple manner, for example via a signal line, although in principle a wireless signal transmission would also be possible.

Advantageously, the temperature sensor can operate contactless. This is particularly advantageous when the temperature sensor is stationary, as there is then no wear due to friction with respect to the cable drum.

Such a stationary temperature sensor can, in particular, be arranged outside the cable drum and face or be aligned with the end face of the cable drum body, whereas the temperature sensor can, in particular, be arranged in the area of a guard plate base which is connected to or adjoins the drum casing.

In order to nevertheless be able to detect the temperature in a cable winch or cable drum portion located in a deeper region with a stationary temperature sensor arranged outside the cable drum, in an advantageous further development of the invention, a temperature conducting member and/or heat conducting member can be provided which protrudes at least partially into a recess which can be configured in the cable winch, in particular in the cable drum. Said temperature conducting member and/or heat conducting member can conduct the temperature or heat from inside the cable winch to the outside, so that a portion of the conducting member located outside the cable winch can be detected in terms of its temperature.

In particular, a reception bore or a bore-like reception recess can be provided, which can extend into the drum casing from one end face of the cable drum. A temperature conducting member and/or heat conducting member, for example in the form of a pin, can be seated at least partially in said reception bore and advantageously extend out of it, for example protruding with a head onto the end face of the cable drum.

A contactlessly operating temperature sensor, for example, can detect the temperature of such a temperature conducting member and/or heat conducting member, whereas for this purpose, for example, the drum can be brought into a rotational position in which the conducting member is positioned to match the stationary temperature sensor.

If necessary, an ring-shaped detection collar can also be attached to the guide element so that a stationary temperature sensor can detect the temperature of the conducting member even without a specific rotational position of the cable winch and/or optionally even when the cable winch is rotating. Such a ring-shaped detection collar can also be particularly advantageous if several temperature conducting members and/or heat conducting members are provided, for example seated in reception bores arranged around the circumference.

In order to actually detect the temperature in the depth of the recess, the recess in the outer portion can be configured with oversize so that a gap or annular gap remains between the conducting member and the recess and no temperature is affected by contact with the perhaps cooler outer portion.

Alternatively or additionally, a stationary temperature sensor may be arranged in a transmission housing and/or mounted to the transmission housing, wherein such transmission housing may extend at least partially inside the drum body and/or may extend at least partially outside the drum body. In this respect, the temperature sensor can be provided outside the drum body or inside the drum body on the transmission housing. In particular, the temperature sensor can be attached to a transmission housing portion which is directly seated on the drum body or on which the drum body is supported in a surface-seated manner.

However, the temperature sensor can also be arranged inside or outside the drum body regardless of whether it is mounted on the transmission housing.

In further embodiments of the invention, the temperature measuring device may also comprise a temperature sensor co-rotating with the cable drum. Such a co-rotating temperature sensor can, in particular, be integrated into the interior of the cable drum or be accommodated in the interior of the cable drum.

Advantageously, such a co-rotating temperature sensor can have a signal transmission module that is configured to operate wirelessly in order to be able to transmit the sensor signals wirelessly to a storage device and/or an evaluation device. Advantageously, such a signal transmission module can have an energy storage device which, like the signal transmission module, can be integrated into the cable drum or received inside the cable drum.

Advantageously, the cable drum can have an inspection maintenance opening and/or maintenance opening through which the temperature sensor and/or the signal transmission module and/or its energy storage device can be accessed and, as the case may be, also removed or replaced. Such an inspection opening and/or maintenance opening can, for example, be provided on the end face in the drum body.

Said energy storage device may be, for example, a battery or an accumulator.

Alternatively or additionally, the temperature sensor and/or its signal transmission module can also be supplied with energy by an energy supply module that generates energy using the rotary movement of the cable drum. Such an energy generation module can, for example, be configured inductively, although, for example, a dynamo can also convert the rotational movement of the cable drum and/or a component connected to it, such as a gear shaft, into energy to supply the signal transmission module.

Such a co-rotating temperature sensor can be attached in particular to an inner casing surface of the cable drum, the position of the temperature sensor advantageously being in the area of the gear mechanism via which the cable drum is driven. For example, the temperature sensor may be located on a drum casing inner surface that is between two planetary gear stages and/or adjacent to a gear stage.

Alternatively or additionally, however, a temperature sensor can also be attached to the cable drum guard plate in a co-rotating manner, for example on an outer side of the guard plate facing away from the cable winding area. Such a temperature sensor can advantageously be provided in the area of the base of the guard plate and/or the transition of the guard plate to the drum casing.

Regardless of the arrangement of the temperature sensor, at least one temperature sensor can also be configured as a temperature switch that emits a signal when a predetermined temperature is reached. This can be a boundary temperature relevant to the cable being wound or a pre-warning temperature to indicate that the boundary temperature or a pre-warning boundary has been reached.

Such a temperature switch can be configured, for example, as a bimetal switch that has a switching element that deforms under temperature and changes a contact state of the switch when the predetermined temperature is reached. Advantageously, the temperature switch may comprise an integrated energy storage device and have a signaling device that provides a signal when the predetermined temperature is reached.

Alternatively or in addition to such a temperature switch, the temperature measuring device may also comprise at least one temperature indicator element that visually indicates that a predetermined temperature has been reached or exceeded. In particular, the temperature indicator element may show a color change when the predetermined temperature is reached or exceeded, so that the temperature rise is indicated by a change in the color of the indicator element. Such a temperature indicator element may, for example, comprise thermochromic pigments whose color changes as a function of temperature.

Advantageously, such a temperature indicator element can be configured to irreversibly change color to permanently indicate that a critical temperature has been reached or exceeded.

However, such a display device for indicating that a predetermined temperature has been reached and/or exceeded and/or cable drum temperatures detected during cable winch operation can also be provided when using the differently configured temperature sensors described above and operate as a function of the sensor signal provided by the at least one temperature sensor. In particular, such a display device may be provided at the control station or, more generally, a controller of the lifting device, which may include, for example, a remote controller, to indicate to the machine operator the cable drum temperature and/or the reaching of a boundary temperature or predetermined temperature.

Advantageously, such a display device is configured to emit at least one warning signal when a cable drum temperature critical for the cable to be wound up is reached or even exceeded.

The display device can in principle be configured in different ways, for example comprising a visual display or another visual display, for example in the form of a flashing light. Alternatively or additionally, an acoustic display device can also be provided for outputting an acoustic warning signal.

In further development of the invention, the detected cable drum temperature can also be further processed by an evaluation device for detecting or processing influences of the cable drum temperature on the remaining service life of the cable. In particular, a determination device can determine the remaining service life and/or replacement state of the cable, taking into account the determined cable drum temperatures, and provide a replacement state signal and/or remaining service life signal as a function of the cable drum temperature.

Such a determination device can, for example, comprise an electronic controller having a microprocessor, which has as an evaluation device for evaluating the temperature signal or signals a software module with an evaluation algorithm that evaluates the temperature signal or signals provided.

In this respect, the determination of the replacement state and/or the remaining service life can, of course, also take into account other operating parameters, for example the load spectrum acting on the cable or environmental influences such as UV light dose, ambient temperature, dust and/or chemical load, or other measured cable parameters such as diameter taper, cable elongation or changes in cable stiffness.

If the replacement state is determined by the said determining device, a corresponding replacement state signal can be displayed on the display device of the cable winch or lifting device. Alternatively or additionally, the replacement state signal can also trigger a shutdown or restriction of the winch operation, for example in such a way that only lifting load lowering movements are possible.

Alternatively or in addition to determining the remaining service life and/or the replacement state, the at least one temperature signal can also be used to intervene in the control of the operation of the cable winch and/or the lifting device.

In further development of the invention, depending on the detected cable drum temperature, the operation of the cable winch can be temporarily stopped for cooling and/or the load spectrum can be reduced. In particular, the controller can be configured to prevent the permissible boundary temperature of the cable from being exceeded due to impermissible heating of the cable drum, i.e., as a function of the cable drum temperature, for example by stopping the operation of the cable winch for cooling before the boundary temperature of the cable is reached or by reducing the load spectrum.

Alternatively or additionally, the controller of the cable winch or lifting device can be configured to initiate cooling measures depending on the detected cable drum temperature, for example, to cause and/or intensify circulation of the gear mechanism lubricant and/or drive lubricant of the cable winch and/or to cause and/or intensify external cooling of the cable drum by air or other media, for example, to switch on a fan wheel and/or set it to a higher speed.

Said controller is generally advantageously configured to set and/or change a control and/or regulation of the temperature balance of the cable drum as a function of the detected cable drum temperature, in particular in such a way that, if the cable drum temperature is too high and/or the cable drum temperature rises too much, a cooling measure for cooling the cable drum is initiated or reinforced.

### BRIEF DESCRIPTION OF THE DRAWINGS

The invention will be explained in more detail in the following with respect to preferred embodiments and to associated drawings. The drawings show:

FIG. 1 a sectional view of a cable winch according to an advantageous explanation of the invention, in which the temperature measuring device comprises a stationary temperature sensor which detects the temperature of the cable drum at a guard plate base in a contactless manner;

FIG. 2 a sectional view of a cable winch similar to FIG. 1, wherein the temperature measuring device has a stationary temperature sensor in a transmission housing of the gear mechanism driving the cable drum;

FIG. 3 a sectional view of a cable winch similar to the foregoing figures, wherein the temperature measuring device has a temperature sensor which co-rotates with the cable drum, is arranged in the region of the gear mechanism inside the cable drum and provides its temperature signal via a wireless signal transmission device inside the cable drum;

FIG. 4 a sectional view of a cable winch similar to FIG. 3, wherein the co-rotating temperature sensor and its signal transmission device are supplied with energy by an energy supply device which converts rotary movements of the cable drum into electrical energy;

FIG. 5 a sectional view of a cable winch similar to the foregoing figures, wherein the temperature measuring device comprises a temperature switch arranged on an outer side of a guard plate of the cable drum;

FIG. 6 sectional and face end views of a cable winch similar to the foregoing figures, the temperature measuring device comprising a temperature indicator element having a visual indication of the cable drum temperature by color change and being visibly arranged on an end face of the cable drum; and

FIG. 7 a sectional view of a cable winch similar to the foregoing figures, the temperature measuring device comprising a temperature guide pin projecting from an end face into a reception bore in the drum casing, a stationary contactlessly operating temperature sensor being provided for detecting the temperature of said temperature guide pin.

### DETAILED DESCRIPTION

As shown in the figures, the cable winch 1 comprises a cable drum 2 with a substantially cylindrical drum casing 3 laterally enclosed on the right and left by guard plates 4. The drum casing 3 can be provided with a groove, but can also be configured to be plain.

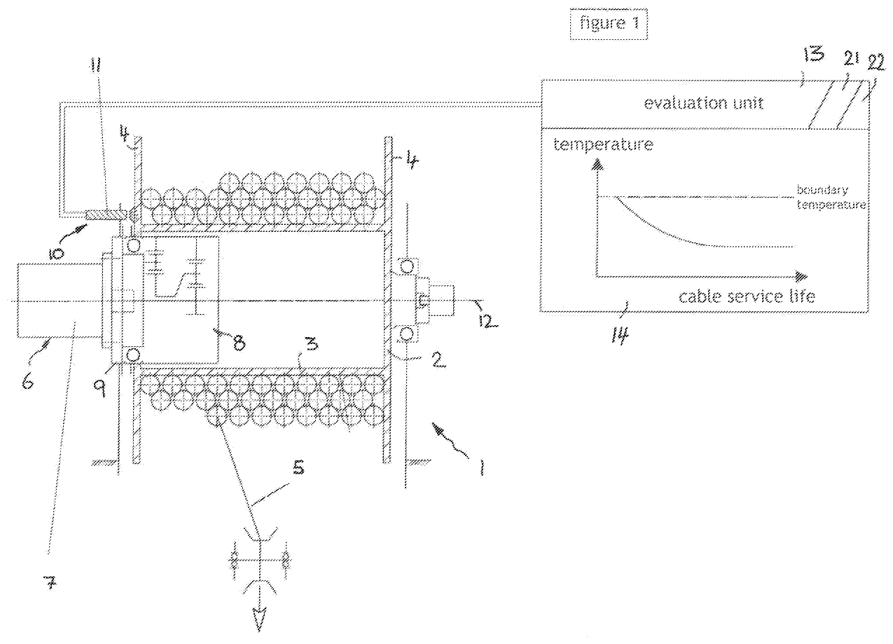

A cable 5 is wound on the drum casing 3 of the cable drum 2 between the guard plates 4, whereby the cable 5 can be wound in a single layer or in multiple layers, cf. FIG. 1.

The cable drum 2 can be driven by a cable winch drive 6, which can have a winch motor or drive 7, for example in the form of an electric motor or a hydraulic motor.

The cable winch drive 6 may further comprise a gear mechanism 8, which may be at least partially arranged inside the cable drum 2. In particular, the gear mechanism 8 may extend into the interior of the drum casing 3 from one side of the drum, and the cable drum 2 may be supported on a transmission housing 9. In particular, the cable drum 2 can be supported on a rotatably mounted housing part and thus be rotatably mounted. In principle, however, it would also be possible to rotatably support the cable drum 2 on a stationary transmission housing part.

As the figures show, the winch drive 7 may be arranged laterally on the cable drum 2, for example flanged to the gear mechanism 8, which extends into the drum casing 3.

The said gear mechanism 8 may, for example, be configured as a planetary gear mechanism and may, for example, have two or more planetary stages. In principle, however, other gearbox configurations and arrangements are also possible.

The cable winch 1 has a temperature measuring device 10 to measure the temperature of the cable drum 2.

Since the cable drum 2 is usually subjected to the greatest heat on the drive side from the gear mechanism 8 or, depending on the configuration of the cable winch drive 6, also from the winch drive 7, and the highest cable drum temperatures occur there, the temperature measuring device 10 is advantageously assigned to the gear and/or drive side of the cable drum or is configured to measure the cable drum temperature on the gear or drive side. In particular, the temperature measuring device 10 may include at least one temperature sensor 11 that measures the temperature of a drum portion arranged on or immediately adjacent to the gear mechanism 8 and/or the winch drive 7. In particular, at least one temperature sensor 11 can be arranged on the guard plate 4 on the gear and/or drive side of the cable drum 2 or on a portion of the drum casing 3 that is located on the gear mechanism 8 or surrounds the gear mechanism 8.

In this respect, different temperature sensors can be provided and/or temperature sensors can be arranged at different locations.

As FIG. 1 shows, a preferably contactlessly operating temperature sensor 11 can be arranged stationary at one end face of the cable drum 2, for example mounted upright on a gear mechanism and/or drive flange, in order to measure the temperature of the cable drum 2 at its end face. In particular, the said temperature sensor 11 can have its measuring area facing a base portion of the guard plate 4 adjacent to the drum casing 3. For example, the temperature sensor 11 may be arranged at a distance from the drum rotation axis 12 that is substantially equal to the radius of the drum casing 3. For example, the temperature sensor 11 can be arranged opposite a first winding layer, cf. FIG. 1.

The temperature sensor 11 can provide its temperature signal cyclically or continuously to an evaluation unit 13, which evaluates the temperature signal, for example, to display a warning message on a display device 14, which can comprise a display, when the cable drum temperature reaches or exceeds a limit value.

Alternatively or additionally, the evaluation unit 13 can evaluate the temperature signal, as the case may be together with further environmental and/or operating parameters and/or other cable parameters, for determining the replacement state and/or remaining service life of the cable 5 taking into account the measured temperature. A replacement state signal and/or a signal reflecting the remaining service life may also be output on said display device 14.

Alternatively or additionally, the replacement state signal and/or remaining service life signal can also be used to shut down or limit the operation of the cable winch 1 when the replacement state is reached or when the cable winch 1 approaches the replacement state of the cable. Alternatively or additionally, the replacement state signal and/or remaining service life signal may be provided to a maintenance and/or scheduling management system to initiate and/or schedule replacement of the cable.

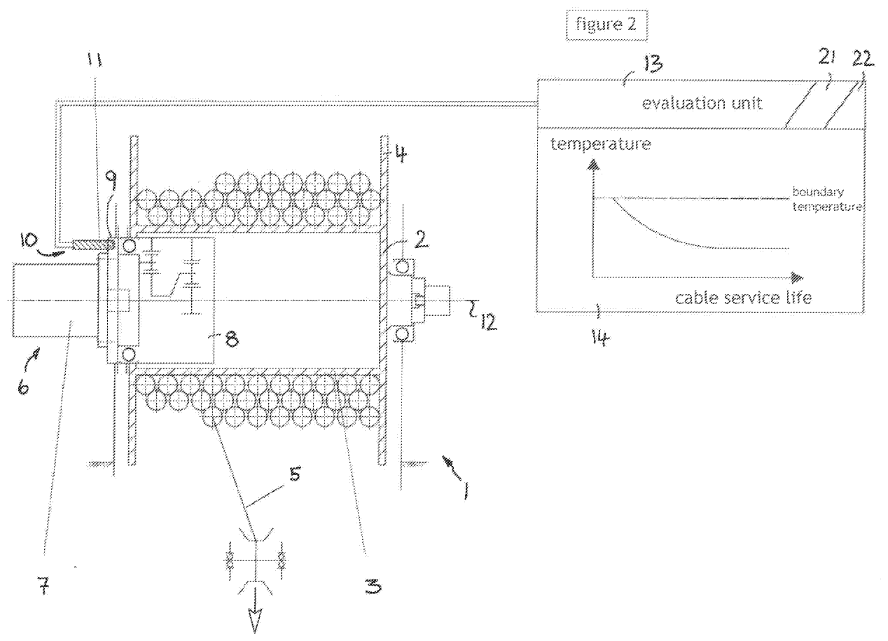

As FIG. 2 shows, the temperature measuring device 10 may also have a temperature sensor 11 mounted on the transmission housing 9 or arranged in the transmission housing 9. In particular, such a temperature sensor 11 may be provided on a portion of the transmission housing 9 positioned immediately adjacent to the cable drum 2 and/or supporting the cable drum 2. For example, the temperature sensor 11 can be led out of the end face of the transmission housing 9 and/or arranged on a stationary portion of the transmission housing 9.

The stationary temperature sensors 11, as shown in FIGS. 1 and 2, can be connected to the evaluation unit 13 in a simple manner, for example by means of a signal transmission cable, although wireless signal transmission would also be possible in principle.

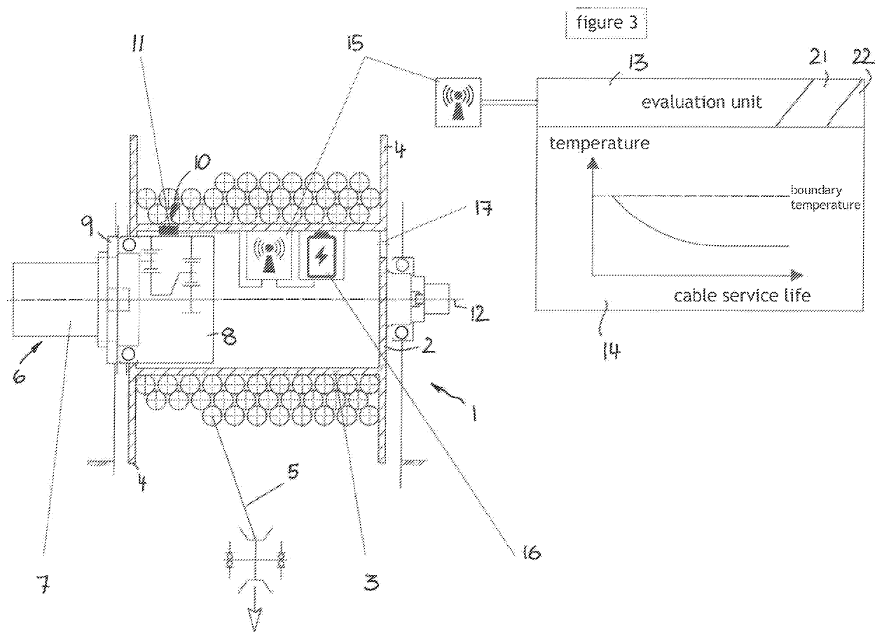

As FIG. 3 shows, however, the temperature measuring device 10 can also have a temperature sensor 11 co-rotating with the cable drum 2, whereby such a co-rotating temperature sensor 11 can advantageously be integrated into the interior of the cable drum 2 and/or be attached to an inner casing surface of the drum casing 3. Advantageously, such a co-rotating temperature sensor 11 can also be arranged on the gear unit side of the cable drum 2, for example on a drum casing portion surrounding the gear mechanism 8, for example in an area between two gear stages, cf. FIG. 3.

The temperature sensor 11 advantageously comprises a wirelessly operating signal transmission device 15, for example in the form of a radio and/or Bluetooth and/or WLAN module, which can transmit sensor signals wirelessly to the evaluation device 13.

Such a signal transmission device 15 can also be adopted inside the cable drum 2 or be mounted co-rotating with the cable drum 2. In principle, it would also be possible to mount the signal transmission device 15 on an outer side of the cable drum 2, for example one of the guard plates 4.

The signal transmission device 15 and/or the temperature sensor 11 can be supplied with electrical energy from an energy storage device 16, whereby such an energy storage device 16 can also be mounted co-rotating on the cable drum 2, for example integrated into the interior, cf. FIG. 3.

In order to be able to maintain and/or replace the temperature sensor 11 integrated inside the cable drum 2, the cable drum 2 can advantageously have a maintenance and/or assembly opening 17 through which the temperature sensor 11 and/or its accessory components such as the signal transmission module or device 15 are accessible and can advantageously also be replaced. For example, such a maintenance and/or assembly opening 17 may be configured in an end face of the cable drum 2 and provide access to the interior of the drum casing 3 from the end face. The maintenance opening and/or assembly opening 17 may be provided immediately adjacent to a bearing flange of the cable drum 2.

Advantageously, the maintenance opening and/or assembly opening 17 can be closed by a cover.

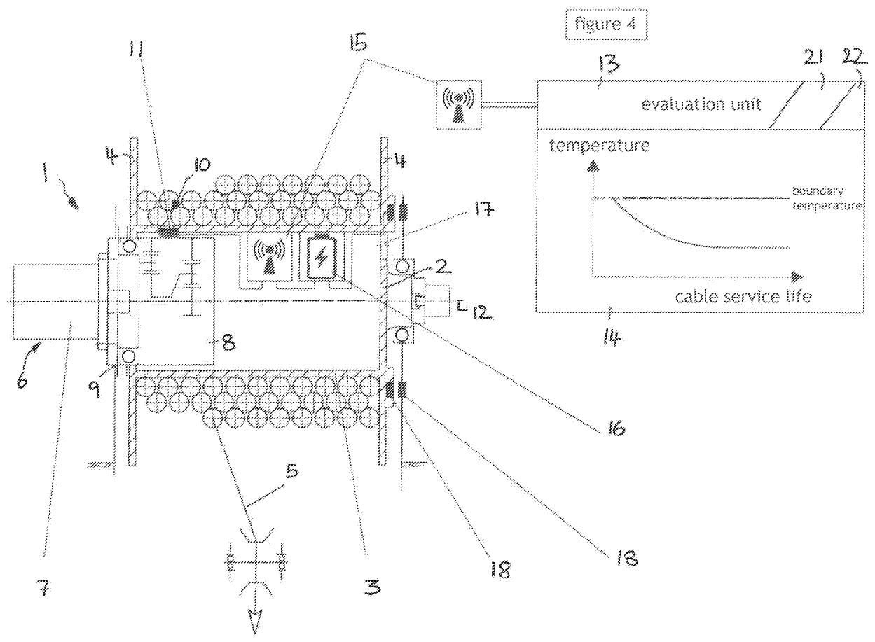

As FIG. 4 shows, the temperature measuring device 10 can also be supplied with electrical energy from an energy generator 18, which generates electrical energy from the rotational movement of the cable drum 2. For example, such an energy generator 18 may be configured to operate inductively and include a co-rotating part and a stationary part with the cable drum 2 so that electrical energy is generated by the movement of the co-rotating and stationary parts. For example, the co-rotating energy generator part can be mounted on a guard plate 4 and the stationary energy generator part can be mounted on a carrier that is located on the end face in front of the guard plate 4, so that the co-rotating and stationary energy generator parts rotate past each other when the cable drum 2 rotates.

In principle, the energy generator 18 can feed the generated energy directly into the signal transmission module 15 or also the temperature sensor 11 or provide these components. Advantageously, however, the generated energy can also be fed into the previously mentioned energy storage device 16, from which the sensor components are then supplied with electrical energy.

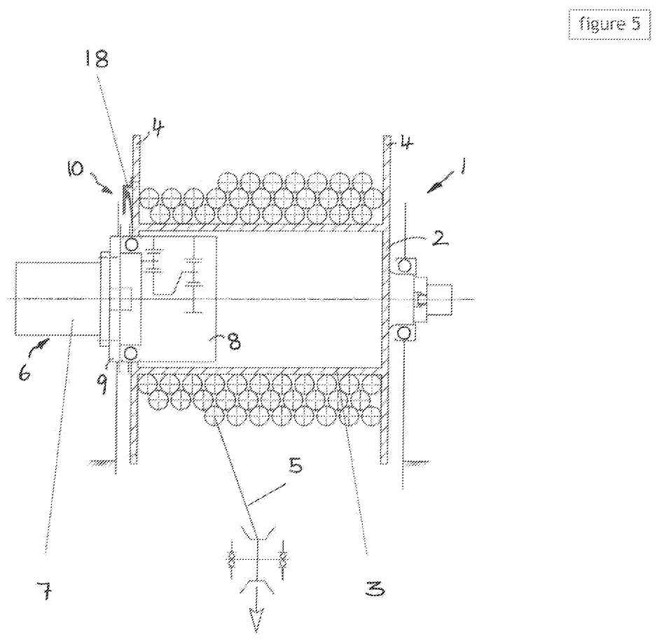

As FIG. 5 shows, the temperature measuring device 10 may also include a temperature switch 19 that provides or enables a signal when a predetermined cable drum temperature is reached. Such a temperature switch 19 may, for example, be configured as a bimetallic switch and have a bimetallic sensor that deforms as the temperature changes and changes a contact circuit, in particular closes a contact, to provide or enable a temperature signal.

Advantageously, the temperature switch 19 can have an energy storage device 16, for example in the form of a battery, for then providing the temperature signal via a signal transmission module 15, which indicates reaching or exceeding or a predetermined temperature, for example the boundary temperature of the cable, or also an approach to this temperature.

The signal provided by the temperature switch 19 can be of various natures, for example comprising an acoustic signal or having an optical signal, for example in the form of a flashing light.

Such a temperature switch 19 can also be arranged on the gear unit side of the cable drum 2, for example, mounted on the end face of the guard plate 4, which is located on the winch drive 7.

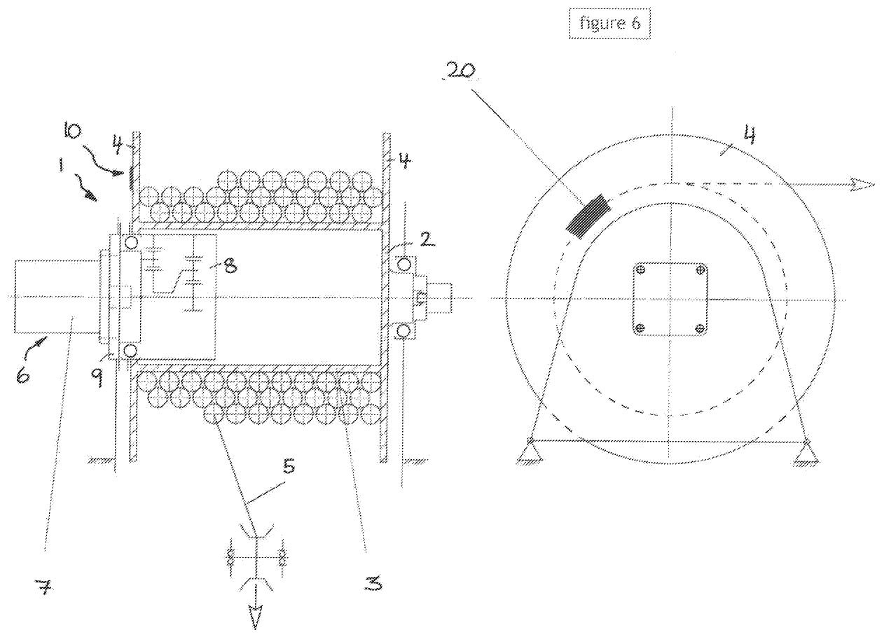

As FIG. 6 shows, the temperature measuring device 10 may also include a temperature indicator element 20 that provides a visual signal or indication in the form of a color change when a predetermined temperature, such as the boundary temperature of the cable, is reached or exceeded. For example, such a temperature indicator element 20 may have thermochromic pigments whose color changes when the temperature rises above a predetermined value.

Advantageously, the temperature indicator element 20 can be irreversibly configured to change color, i.e., to retain its changed color indicating the increased temperature even if the temperature drops again. This means that even after overheating has occurred, for example even when the cable winch is switched off, it can be determined retrospectively that the cable drum 2 had exceeded a predetermined temperature limit.

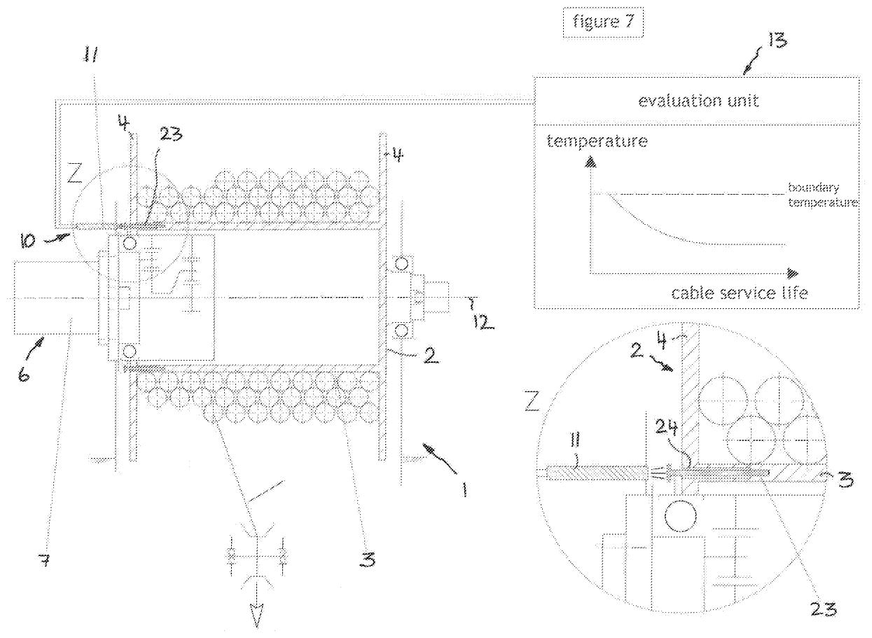

As FIG. 7 shows, the temperature monitoring device 10 may also include a temperature conducting member and/or heat conducting member 23 that allows an easily accessible positioned temperature sensor 11 to detect the cable drum temperature at an inaccessible location. Advantageously, said temperature conducting member and/or heat conducting member 23 may extend at least partially into a recess 24 configured in or extending into an interior portion of the cable drum and may be open to an outer side of the cable winch 1.

For example, a reception bore can lead into the drum casing from one end face, cf. FIG. 7, and the, for example, pin-shaped temperature conducting member and/or heat conducting member 23 can be seated in this reception bore, whereby advantageously the conducting member 23 can look out of the reception bore 24 with a head portion, cf. FIG. 7.

In this regard, the temperature measuring device 10 may advantageously comprise a stationary temperature sensor 11 capable of contactlessly detecting the temperature of the cable drum 2 via said temperature conducting member and/or heat conducting member 23.

Advantageously, said recess, in particular the reception bore 24, can be configured in the area of a guard plate base and be larger in diameter or clear width than the diameter or thickness of the temperature conducting member and/or heat conducting member 23, so that no heat transfer by contact takes place in this enlarged recess area, cf. the enlarged portion Z of FIG. 7. A base portion of the pin-shaped temperature conducting member and/or heat conducting member 23 can fit accurately in a wider or deeper portion of the reception bore 24 to detect the temperature there or to accept the temperature and heat of the drum portion. Advantageously, the recess 24 can be configured in the form of a stepped bore.

Advantageously, the temperature can be detected specifically inside the drum casing 3 at a desired location, although a stationary temperature sensor 11 is used.

For determining the temperature of the conducting member 23, the cable drum 2 can be set in such a way that the temperature sensor 11 is opposite the conducting member 23 or can detect the temperature at the conducting member 23.

Alternatively, however, several temperature conducting members and/or heat conducting members 23 can be fitted, for example in reception bores 24 arranged around the circumference and leading into the drum casing 3 from the end face in the manner shown in FIG. 7.

Advantageously, the temperature conducting member and/or heat conducting members 23 can be connected to a ring-shaped detection collar, for example in the form of a ring-shaped metal sheet, via which the temperature sensor 11 can advantageously continuously detect the temperature without having to bring the cable drum 2 into a specific rotational position. In particular, the temperature sensor 11 can be configured to operate contactlessly.

Advantageously, the monitoring of temperature of the cable drum 2 described can be used to deduce the temperature of the cable 5 and thus avoid serious danger points.

However, the monitoring of temperature can also be used to ensure safe operation of the cable winch 1 with a high-strength fiber rope that has a relatively low permissible boundary temperature. This eliminates the need to use fiber ropes with relatively high permissible boundary temperatures due to the heating of the cable drum 2. At the same time, the permissible boundary temperature of a fiber rope can be better exploited. At the same time, this allows a wider range in terms of material selection in the manufacture of fiber ropes, which means that other rope properties can be positively influenced accordingly.

Advantageously, the monitoring of temperature described can enable safe operation of the cable winch with a fiber rope even in conveyor systems with difficult boundary conditions, for example in the case of relatively high ambient temperatures or operation of the cable winch with a load spectrum that leads to high gearbox heating.

We claim:

1. A cable winch comprising:
a cable drum configured to have a cable wound onto the cable drum; and
a temperature measuring device for measuring a temperature of the cable drum.

2. The cable winch of claim 1, wherein the temperature measuring device is on a gear unit side of the cable drum for determining the temperature of a cable drum portion surrounding or adjacent to a winch transmission.

3. The cable winch of claim 1, wherein the temperature measuring device comprises at least one stationary temperature sensor with respect to which the cable drum is rotatable.

4. The cable winch of claim 3, wherein the at least one stationary temperature sensor is arranged at least partially on an outer side on an end face of the cable drum.

5. The cable winch of claim 4, wherein the temperature sensor is configured to operate in a contactless manner and is directed with a detection region of the temperature sensor toward a guard plate base portion of the cable drum.

6. The cable winch of claim 1, further comprising at least one temperature conducting member and/or heat conducting member, wherein the at least one temperature conducting member and/or heat conducting member is at least partially received in a cavity of the cable winch open towards an outer side and the temperature of which is detected by a temperature sensor arranged outside the cavity.

7. The cable winch according to claim 6, wherein the at least one temperature conducting member and/or heat conducting member is seated in a reception bore which extends into the cable drum and is open towards an end face of the cable drum, wherein the temperature and/or heat conducting member protrudes from the end face of the cable drum towards said end face, and further comprising a stationary, contactless operating sensor for detecting the temperature of the portion of the temperature conducting member and/or heat conducting member protruding from the cable drum.

8. The cable winch according to claim 7, wherein the reception bore has an oversize in an outer portion arranged towards the cable drum end face with respect to the at least one temperature conducting member and/or heat conducting member, so that there is no contact between the reception bore and the at least one temperature conducting member and/or heat conducting member, and wherein the temperature conducting member and/or heat conducting member contacts the cable drum material only in a deeper portion of the reception bore.

9. The cable winch of claim 1, wherein the temperature measuring device comprises at least one temperature sensor in a transmission housing of a cable winch drive or mounted on the transmission housing.

10. The cable winch of claim 1, wherein the temperature measuring device comprises at least one temperature sensor co-rotating with the cable drum.

11. The cable winch of claim 10, wherein the co-rotating at least one temperature sensor is integrated into the interior of the cable drum.

12. The cable winch of claim 11, wherein the temperature sensor is on an inner casing surface of a drum casing of the cable drum and/or is between a gear mechanism of a cable winch drive and the drum casing of a cable winch.

13. The cable winch of claim 1, wherein the temperature measuring device comprises a contactlessly operating signal transmission device for transmitting a temperature signal.

14. The cable winch of claim 1, further comprising a signal transmission device integrated into the interior of the cable drum and/or mounted co-rotatingly with the cable drum.

15. The cable winch of claim 1, wherein the temperature measuring device comprises an energy generator for generating electrical energy from rotary movement of the cable drum.

16. The cable winch of claim 1, wherein the temperature measuring device comprises a temperature switch for providing a temperature signal when a predetermined limit temperature of the cable drum is reached and/or exceeded.

17. The cable winch of claim 1, wherein the temperature measuring device comprises at least one optically operating temperature indicator which changes color when a predetermined limit temperature is reached or exceeded.

18. The cable winch of claim 17, wherein the temperature indicator is configured to irreversibly change color.

19. The cable winch of claim 1, further comprising a determination device for determining a replacement state and/or a remaining service life of the cable in dependence on the temperature of the cable drum determined by the temperature measuring device.

20. The cable winch of claim 19, further comprising:
a display device for displaying the replacement state and/or the remaining service life; and/or
a transmission device for transmitting the replacement state and/or remaining service life to a maintenance planning device.

21. The cable winch of claim 1, further comprising a controller for temporarily shutting down and/or temporarily reducing a load spectrum and/or winch power and/or winch speed in dependence on the cable drum temperature determined by the temperature measuring device.

22. The cable winch of claim 1, further comprising a controller for switching on and/or increasing a cooling measure in dependence on the cable drum temperature, wherein the controller is configured to start and/or increase a circulation of a winch drive lubricant and/or gear mechanism lubricant and/or to start or increase an external cooling of the cable winch by a fan when the cable drum temperature determined by the temperature measuring device approaches, or reaches, or exceeds a predetermined temperature limit.

23. A lifting device comprising the cable winch of claim 1.

24. The lifting device of claim 23, comprising a crane, wherein the cable winch forms a hoisting cable winch of the crane.
